(19) United States
(12) Patent Application Publication
(10) Pub. No.: US 2018/0365618 A1
(43) Pub. Date: Dec. 20, 2018

(54) System And Method For Assessing Worker Engagement And Company Culture

(71) Applicant: Workrize, PBC, DBA as Workrise, San Francisco, CA (US)

(72) Inventors: Anne Hardy, San Francisco, CA (US); Marylene Delbourg-Delphis, Menlo Park, CA (US); Dominique Hermsdorff, Los Gatos, CA (US); Geoffrey Lee, South San Francisco, CA (US)

(21) Appl. No.: 16/011,429

(22) Filed: Jun. 18, 2018

Related U.S. Application Data
(60) Provisional application No. 62/521,072, filed on Jun. 16, 2017.

(51) Int. Cl. G06Q 10/06; G06Q 10/10

(52) U.S. Cl. CPC G06Q 10/06393; G06Q 10/10

(57) ABSTRACT

A method for assessing worker engagement and company culture. The method includes generating questions relating to a user's work experience, determining a set of predetermined times during the user's workday to prompt the user to answer the questions, and prompting the user at each of the predetermined times to provide an answer, in real time, to each of the questions. Answers may be received from the user and then correlated with contextual data associated with the user. A corresponding system and computer program product are also disclosed and claimed herein.

### RELATED APPLICATIONS

This application claims the benefit of U.S. Provisional Application Ser. No. 62/521,072, filed Jun. 16, 2017 which is hereby incorporated herein by reference in its entirety for all purposes.

### BACKGROUND

### Field of the Invention

This invention relates to systems and methods for analyzing work environments.

### BACKGROUND OF THE INVENTION

Most corporations and other workplaces strive for worker satisfaction, since great workers are an organization's number one resource. Keeping workers happy and committed helps strengthen a company by lowering turnover, increasing productivity, strengthening sales and ensuring a healthy bottom line, and fostering loyalty, which helps to spread goodwill.

Ensuring workers are cognitively, behaviorally and emotionally engaged and satisfied, however, requires more than just good pay and benefits. Other frequently cited factors in job satisfaction include respect, trust, security, healthy environment, and an established career path. Since these factors are not static, organizations must solicit feedback from workers to be able to gauge their successes or failures in these areas. This information may educate decision-makers, thereby allowing them to take necessary steps to create the kind of working environment they desire for their workers, and that their workers desire.

Existing applications to track aspects of worker engagement and satisfaction rely on data and collection methodologies that limit the scope and value of the collected data. For example, such applications may gather abstracted data that is devoid of context. Where data reporting is performed after a certain event, data accuracy may be diminished due to imperfect recollection of events and external factors that introduce uncontrolled biases. Such applications may also fail to capture the high degree of variability of a worker's experience over time.

What are needed are systems and methods for assessing worker engagement and satisfaction that substantially eliminate biases, data misinterpretation, and flawed correlations. Also what are needed are systems and methods that collect more and better data, and that capture the context and time at which the data is collected. Ideally, such systems and methods would track data over time, examine variations in the data over that time period, and capture the complexity of individual workers' experiences.

### BRIEF DESCRIPTION OF DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a is a high-level block diagram showing one example of a computing system in which a system and method in accordance with the invention may be implemented;

FIG. 2 is a high-level block diagram of a system for assessing worker engagement and company culture in accordance with embodiments of the invention;

FIG. 3 is a schematic diagram of a system for assessing worker engagement and company culture in accordance with certain embodiments of the invention;

FIGS. 4A and 4B are front views of a mobile device showing examples of a graphical user interface posing questions to users in accordance with various embodiments of the invention;

FIG. 5 is a schematic diagram of one method of populating questions and returning answers to a server in accordance with embodiments of the invention;

FIG. 6 is a high-level block diagram of a server with an interface for client applications to retrieve user data for a check-in in accordance with certain embodiments of the invention;

FIGS. 7A, 7B, and 7C are front views of a mobile device showing examples of a graphical user interface for displaying an individual report to a user in accordance with the present invention;

FIGS. 8A and 8B are front views of a mobile device showing examples of a graphical user interface for presenting insights and articles to a user in accordance with embodiments of the invention;

FIG. 9 is a schematic diagram of a method for providing personalized content and recommendations in accordance with certain embodiments of the invention;

FIG. 10 is a high-level block diagram of components of an organizational analysis in accordance with certain embodiments of the invention;

FIG. 11 is a graph illustrating correlations between a construct and its components in accordance with one embodiment of the invention;

FIG. 12 is a graph depicting aggregate moods of an organization's workers in accordance with one embodiment of the invention;

FIG. 13 is a graph mapping an aggregate of workers' emotions associated with a product launch in accordance with another embodiment of the invention;

FIG. 14 is a schematic diagram of an artificial intelligence mentor for worker well-being in accordance with certain embodiments of the invention; and

FIG. 15 is a flow chart depicting a method of continuous monitoring and improvement of worker experience in accordance with embodiments of the invention.

### DETAILED DESCRIPTION

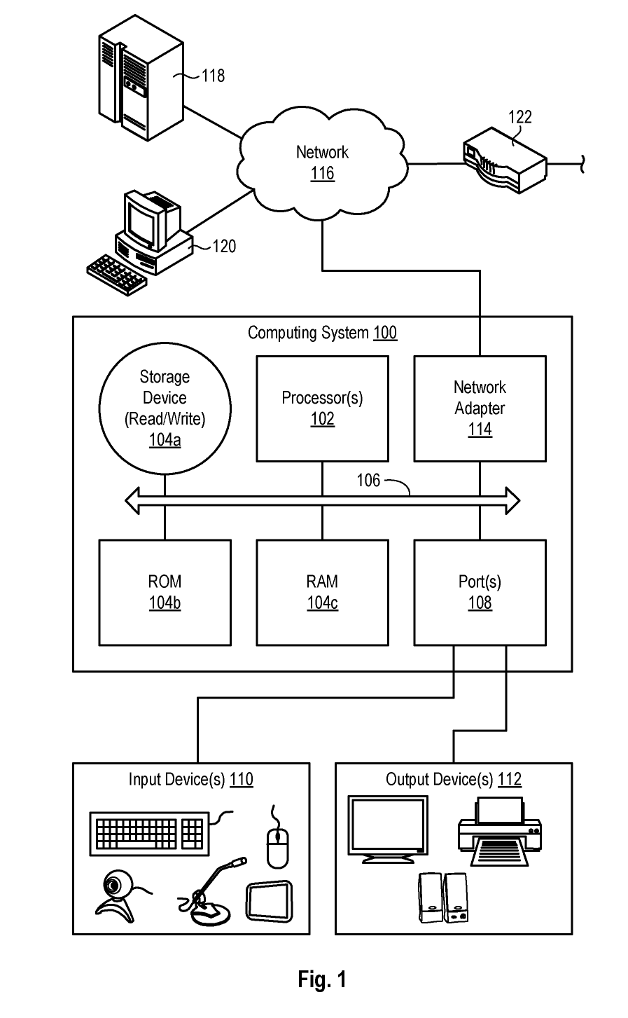

Referring to FIG. 1, one example of a computing system 100 is illustrated. The computing system 100 is presented to show one example of an environment where a system and method in accordance with the invention may be implemented. The computing system 100 may be embodied as a mobile device 100 such as a smart phone or tablet, a desktop computer, a workstation, a server, or the like. The computing system 100 is presented by way of example and is not intended to be limiting. Indeed, the systems and methods disclosed herein may be applicable to a wide variety of different computing systems in addition to the computing system 100 shown. The systems and methods disclosed herein may also potentially be distributed across multiple computing systems 100.

As shown, the computing system 100 includes at least one processor 102 and may include more than one processor 102. The processor 102 may be operably connected to a memory 104. The memory 104 may include one or more non-volatile storage devices such as hard drives 104a, solid state drives 104a, CD-ROM drives 104a, DVD-ROM drives 104a, tape drives 104a, or the like. The memory 104 may also include non-volatile memory such as a read-only memory 104b (e.g., ROM, EPROM, EEPROM, and/or Flash ROM) or volatile memory such as a random access memory 104c (RAM or operational memory). A bus 106, or plurality of buses 106, may interconnect the processor 102, memory devices 104, and other devices to enable data and/or instructions to pass therebetween.

To enable communication with external systems or devices, the computing system 100 may include one or more ports 108. Such ports 108 may be embodied as wired ports 108 (e.g., USB ports, serial ports, Firewire ports, SCSI ports, parallel ports, etc.) or wireless ports 108 (e.g., Bluetooth, IrDA, etc.). The ports 108 may enable communication with one or more input devices 110 (e.g., keyboards, mice, touchscreens, cameras, microphones, scanners, storage devices, etc.) and output devices 112 (e.g., displays, monitors, speakers, printers, storage devices, etc.). The ports 108 may also enable communication with other computing systems 100.

In certain embodiments, the computing system 100 includes a wired or wireless network adapter 114 to connect the computing system 100 to a network 116, such as a LAN, WAN, or the Internet. Such a network 116 may enable the computing system 100 to connect to one or more servers 118, workstations 120, personal computers 120, mobile computing devices, or other devices. The network 116 may also enable the computing system 100 to connect to another network by way of a router 122 or other device 122. Such a router 122 may allow the computing system 100 to communicate with servers, workstations, personal computers, or other devices located on different networks.

As previously mentioned, most employers strive to achieve productive and satisfying workplaces for their workers. This goal, however, is difficult to achieve without an accurate understanding of workplace conditions, attitudes, and experiences, and the interplay between those factors and the end goal. While certain data collection systems exist to track aspects of worker engagement and satisfaction, they are limited in their usefulness as they neglect to provide context for the data and to report the data in real-time. An organization's ability to self-correct is thus reduced. Systems and methods in accordance with the present invention address these issues.

As used herein, the terms “question” and “query” may be used substantially interchangeably to refer to a request for information. Likewise, the terms “answer” and “response” may be used substantially interchangeably to refer to a response to a question.

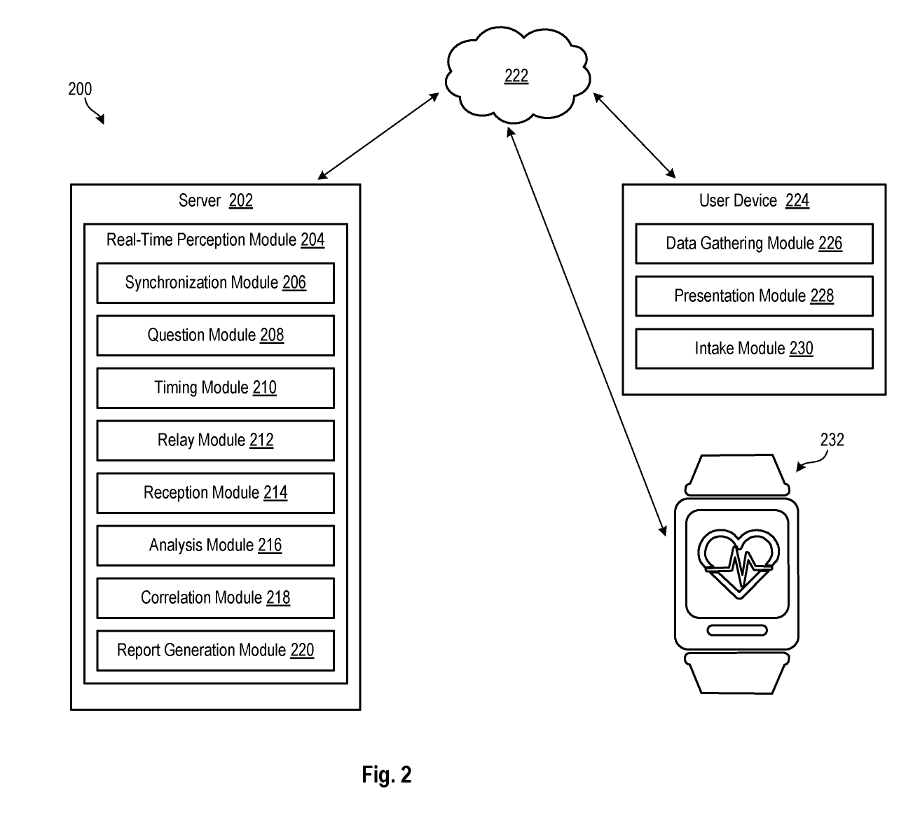

Referring now to FIG. 2, a system 200 in accordance with one embodiment of the invention may include a server 202 in communication with a user device 224 via the cloud 222. In some embodiments, the server 202 may also communicate with a personal biometric device 232 via the cloud 222. In this manner, a system 200 in accordance with embodiments of the invention may uniquely combine and calibrate multiple data sources to provide highly contextualized data, or “thick data,” capable of accurately reflecting a user's experience in the workplace. Of course, the server 202 may be locally or remotely located, and may communicate with the user device 224 and/or personal biometric device 232 by way of any appropriate wired or wireless communications technology known to those in the art, such as a Wi-Fi connection, cellular data connection, the internet, or the like.

The server 202 may include a real-time perception module 204 to analyze worker engagement and company culture in substantially real time in accordance with embodiments of the invention. In one embodiment, the real-time perception module 204 may receive and utilize information from the user device 224 and/or the personal biometric device 232 reflecting emotions and behavior related to a user's working environment. Based on this information, the real-time perception module 204 may provide insights and personalized recommendations to workers and their organizations.

In some embodiments, the real-time perception module 204 may include multiple sub-modules to perform pertinent tasks. In one embodiment, for example, the real-time perception module 204 may include a synchronization module 206 to gather data obtained from a personal biometric device 232 associated with a user. A personal biometric device 232 may include, for example, a FitBit® tracker or other personal tracker or fitness device, a mobile phone or other device, a smart watch, a sensor, a sleep monitoring system, a fitness device, or any other such device known to those in the art to automatically monitor a user's physical well-being throughout a specified time period, depending on user settings. The personal biometric device 232 may track, for example, a user's heart rate, sleep, nutrition, exercise and/or temperature, and, in some embodiments, may correlate such information with a date, time, geographical location of the user, and the like.

Similarly, a user device 224 may include a data gathering module 226 to monitor and gather data regarding time spent on various projects, typing speed, periods of inactivity, time spent on the internet, time spent on email, and the like. The user device 224 may also include a presentation module 228 to receive and present to a user questions generated by the question module 208 and to record answers thereto, as discussed in detail below.

The question module 208 may be included in the real-time perception module 204 to generate questions and/or sets of questions (also referred to herein as “check-ins”) related to particular themes of interest in a work environment. Themes may include, for example, behavioral traits of the user, organizational effectiveness, organizational efficiency, or the like. The question module 208 may posit questions as multiple-choice, bounded range, sliding scale, or free-form questions, or in any other form known to those in the art. Importantly, the question module 208 may utilize multi-factorial data collection, such that the nature of the questions posited capture the context of emotions and conditions reported for a certain period of time, or “episode,” in a user's workday. To this end, questions may fall into two main categories: (1) collection of emotions connected to an episode; and (2) collection of responses to questions with various levels of connection to the episode.

For example, in certain embodiments, questions may ask a user to select tasks and operations in which the user is typically involved during his or her workday. In one embodiment, for example, a user may select “Design/Development,” “Documentation,” “Team Management,” or the like. Tasks and operations may be customized based on the type of work performed. Other questions may ask a user to indicate time spent on an activity, for example, fifteen minutes, thirty minutes, one hour, etc. Questions may further ask the user to indicate the social or physical environment in which he or she operates, such as alone, with a teammate, with a manager, with a subordinate, or the like.

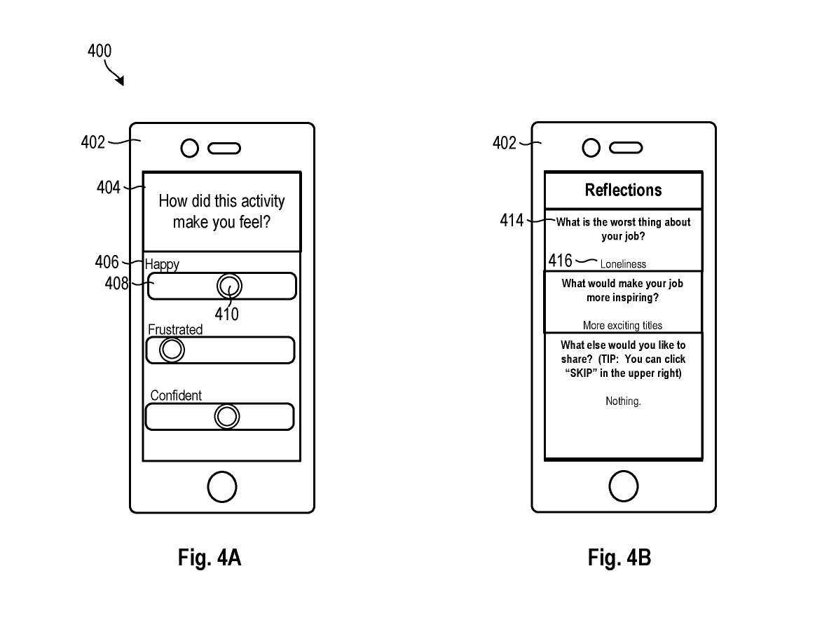

Other questions may collect the user's self-reported ratings from a configurable selection of emotions during an episode. In some embodiments, for example, users may rate their emotions on an ordinal scale, as described in more detail with reference to FIG. 4 below. In other embodiments, questions may enable a user to select an emotion from multiple choices, or to identify their emotions in a free-form answer.

The real-time perception module 204 may further include a timing module 210 to determine a set of predetermined times during the user's workday to prompt the user to answer questions generated by the question module 208, or “check-in.” In some embodiments, the timing module 210 may enable the user to provide one or more intervals of time during the workday during which the predetermined times may fall. In certain embodiments, an organization or employer may set the predetermined times for check-ins where questions generated by the question module 208 may be presented to users.

In one embodiment, questions generated by the question module 208 may be presented to users two or three times, or more, each workday. In other embodiments, answers from previous check-ins, edits and prioritizations of questions from the question module 208 and/or organization administrator may be used to establish a schedule of future check-ins.

A relay module 212 may be included in the real-time perception module 204 to relay questions generated by the question module 208 to one or more user devices 224. A user device 224 associated with a user may include, for example, a cellular telephone, a mobile device, a laptop computer, a desktop computer, or any other such device known to those in the art. The relay module 212 may push the questions from the server 202 to the user device 224 and may notify the user that it is time for a check-in. In certain embodiments, the relay module 212 may sound an alarm, send a text message, or otherwise utilize existing features of the user device 224 to alert the user to complete the check-in.

A reception module 214 associated with the real-time perception module 204 may receive answers provided by the user at the check-in. Depending on the form of the question generated by the question module 208, the answers may include a letter, number, or other character indicating a selected answer from multiple answer choices, a free-form response, or any other type of answer known to those in the art. In some embodiments, an answer may include a photograph, a voice message, a text message, or other verbal or non-verbal response known to those in the art.

An analysis module 216 may analyze the answers received by the reception module 214, in addition to other data received by the user device 224 and/or personal biometric device 232. These answers and data may be data mined and analyzed with data science, machine learning, and artificial intelligence (“AI”) methods to provide both quantitative and qualitative analyses, and to enable modeling of high-dimensional data, as discussed in more detail below. In some embodiments, the analysis module 216 may analyze answers and other data received from multiple users, and may aggregate at least a portion of that information to provide contextual data for individuals or, in some embodiments, organizations.

A correlation module 218 may correlate answers and data received by the reception module 214 module with their corresponding questions, as well as with other related answers and data. Based on these correlations from the correlation module 218 and the analysis from the analysis module 216, the report generation module 220 may generate a personalized report with individual insights and recommendations for the user or organization.

This report may be transferred to the user or organization by way of a intake module 230 on a user device 224. The intake module 230 may receive the report and provide a visual representation of the report to a user via a graphical user interface (“GUI”) on a user device 224, for example. The report may visually represent the results of the analysis module 216 and correlation module 218, as well as provide a visual representation and/or links to suggested articles, recommended websites or other materials, or the like. In some embodiments, the intake module 230 may also provide audible or tactile feedback to the user to communicate or enhance report results as desired.

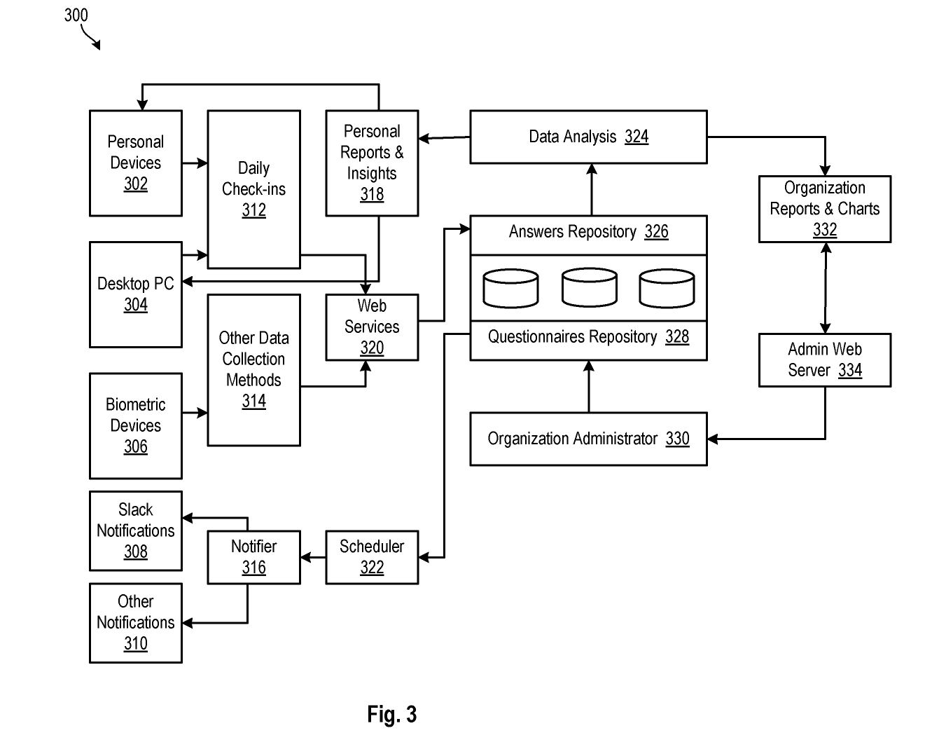

Referring now to FIG. 3, a system 300 for assessing worker engagement and company culture in accordance with certain embodiments of the invention is illustrated. When running, an application installed on a personal device 302, a desktop personal computer 304, or the like, may detect whether a check-in is due. If the application is not running, the user may receive a notification via an associated personal device 302, desktop personal computer 304, or the like. In the case of a desktop personal computer 304, the user may be notified via a slack notification or the like, and may be prompted to complete the check-in in the web browser. The user may then complete a check-in 312 as described above with reference to FIG. 2.

In certain embodiments, the user may be prompted to synchronize data from one or more personal biometric devices 306, such as a personal FitBit® tracker. Depending on the device settings and user authorization, the application may synchronize the personal biometric device 306 data substantially automatically. In some embodiments, the personal biometric device 306 data may be correlated with other data, such as responses 314 to questions posed to the user by the system 300.

Check-in responses 314 and data from personal biometric devices 306 may be received by a web services endpoint 320 and stored in corresponding repositories 326. This data may then be data mined, analyzed 324 with data science, machine learning and AI methods to produce personal reports 318, insights, related articles and suggested reading, organizational reports, and the like. In some embodiments, the personal reports and insights may be pulled from the server by an application or web browser. These reports, insights, articles, recommendations, and the like may then be communicated back to the user via an associated personal device 302, desktop personal computer 304, or other such device.

Based on answers from previous check-ins, as well as edits and prioritizations of questionnaires 328 formulated by the system 300 and/or organization administrators, a system scheduler 322 may establish the schedule for future check-ins, and may communicate the schedule to an application stored on a personal device 302 or desktop personal computer 304 associated with the user.

In some embodiments, if the application or web browser is not running, a system notifier 316 may notify the user of the arrival of a new check-in. On a mobile personal device 302, for example, the user may open the application from a mobile or other notification 310. On a desktop personal computer 304, for example, the user may click on a web link embedded in a slack notification 308.

In certain embodiments, results of the data analysis 324 may be compiled into organizational reports or charts 332 that may be presented via a system website or web server 334 to an organization administrator 330 or other authorized user. Using the system website, an organization administrator 330 or other authorized user may access and/or download organizational reports or charts 332, in addition to aggregated data for more than one anonymous user. In some embodiments, this information may be utilized or further analyzed by other systems.

In one embodiment, an organization administrator 330 or other authorized user may edit, prioritize, or otherwise provide feedback regarding the content of questionnaires 328 used for future check-ins. These changes and feedback may be based on the organization reports or charts 332, and/or upon further analysis of the anonymous aggregated data. In any case, enabling adjustments to the content and presentation of questions in this manner may facilitate a targeted approach to addressing and monitoring specific company needs and conditions.

Referring now to FIGS. 4A and 4B, certain embodiments of the invention may present a user with a graphical user interface 400 presenting questions to the user in various forms. As a preliminary matter, the graphical user interface 400 may query the user to create a private account with customizable account settings. For example, in one embodiment, the graphical user interface 400 may query the user to set up a user profile containing demographic information, indicating regular workdays and time periods normally at work, and the like.

As previously mentioned, questions presented to a user may pertain to one of two general categories: (1) collection of emotions connected to an episode; and (2) collection of responses to questions with various levels of connection to the episode. As shown in FIG. 4A, one embodiment of the present invention may include a graphical user interface 400 presented on a mobile device 402 of a user. The graphical user interface 400 may present to the user a question 404 regarding an emotion associated with a particular episode, such as “How did this activity make you feel?”

The graphical user interface 400 may further present multiple answer choices 406, such as “Happy,” “Frustrated,” or “Confident.” In some embodiments, as shown, the graphical user interface 400 may enable the user to rate each of the answer choices 406 on an ordinal or spatial scale 408. In certain embodiments, a numerical value may be assigned to a user's indication of placement on the spatial scale 408.

In an alternative embodiment, as depicted by FIG. 4B, a graphical user interface 400 may present free-form questions 414 or reflections to the user. This type of question 414 may enable the user to capture an emotion, problem, solution, or the like, in his or her own words. As shown, one question 414 of this type may ask “What is the worst thing about your job?” Other questions 414 may ask, for example, “What would make your job more inspiring?” or “What else would you like to share?” The user may provide any answer 416 he or she desires. In some embodiments, the form of the answer 416 may be typed or handwritten, but may also include any visual, audible, or tactile mode of communication known to those in the art.

In any case, a numerical value corresponding to the answer choice 406 or assigned to an answer 416 may be used to compute a common measure or “NetAffect™” of mood. In some embodiments, the NetAffect™ may be calculated as an average of positive emotions less an average of negative emotions. In some embodiments, another metric (referred to herein as a “U-index”) may be calculated to correspond to a proportion of time an individual spends in an undesirable or unpleasant state. Numerical values corresponding to answer choices 406 and answers 416 may also be used to make this calculation.

Capturing and calculating values corresponding to emotions in this manner enables such emotions to be analyzed within their contexts. Such emotions may thus be understood in relation to all influencing factors. For example, a worker may consistently indicate a high level of stress in meetings with a manager, but may not report stress in other contexts. This may indicate a difficult manager-subordinate relationship rather than other internal or external sources of stress.

In addition, assigning values to answer choices 406 may facilitate accurately aggregating the reported emotions of multiple users. This is important because emotions in recurring contexts are critical to assess all aspects of the organizational behavior, human resources, or management constructs. For example, a “work engagement” construct which can be seen as a personal feature characterizing a worker, may also be analyzed as a collective or interpersonal phenomenon.

Further, measuring this type of phenomena reliably and accurately may be difficult, if not impossible, through de-contextualized surveys. While such surveys may identify a manager-subordinate relationship problem, it may not be able to identify whether the problem is isolated or general, whether it is related to certain demographic profiles, or whether its occurrence is so uncharacteristic that no corrective action is needed at the organizational level.

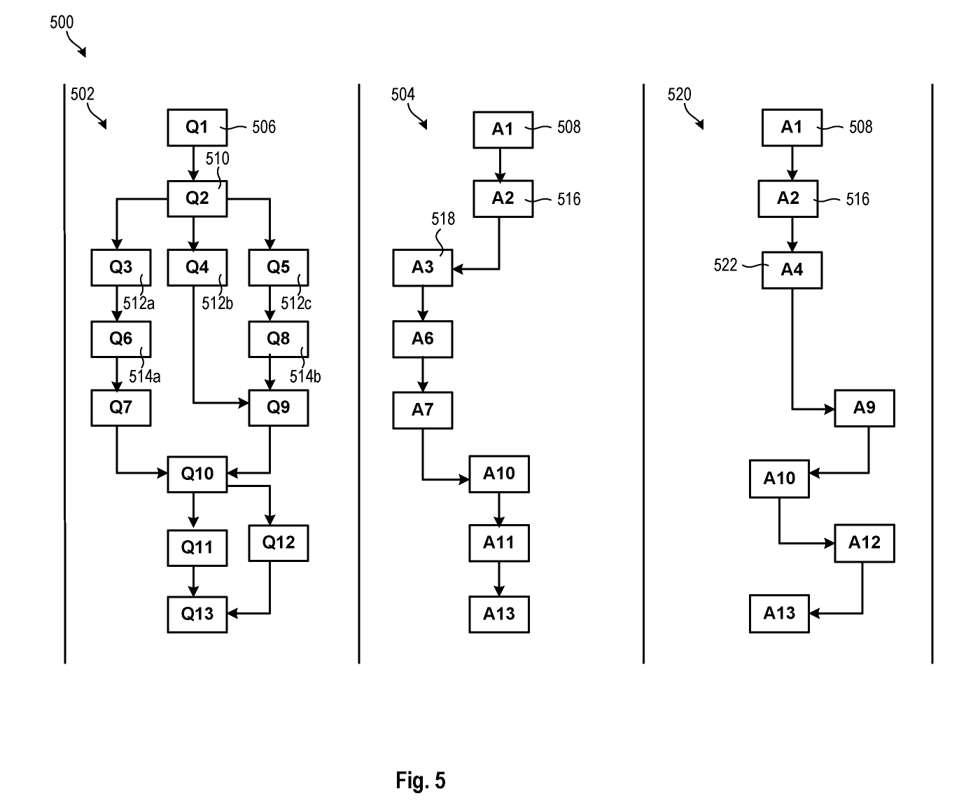

Referring now to FIG. 5, one embodiment of a method 500 for populating questions 506 and returning answers 508 to a server is shown. In some embodiments, the overall characteristics of a particular episode may not require additional questions 506. Further, depending on the context, questions 506 may call for different types of answers 508. Additionally, in some embodiments, questions may be asked with a certain probability. For example, some questions may be asked at each check-in, other questions may be asked about 30% of the time, while others may be asked in the afternoon only, or at most once a day.

In one embodiment, for example, questions 506 may provide observational assessment related to an episode or workday that solicits simple answers 508 based on obvious facts or awareness. These types of questions 506 may require answers 508 such as yes or no, not at all, a little, moderately, very much, extremely, not enough, ideal, too much, or the like.

In other embodiments, questions 506 may provide evaluative assessment related to the episode, workday, or overall worker experience. Such questions 506 may include, for example, “How many hours did you spend in meetings today that were not a good use of your time,” “Did this activity take advantage of your strengths,” or “Overall, how satisfied are you with your job?” These types of questions 506 may involve various levels of cognition, inferences or conjectures.

In any case, such questions 506 and follow-up questions 510, 512a, 514a may be asked based on the analysis of the overall configuration of the episode, including the activity and emotional status of the worker. In this manner, the content and organization 502 of such questions 506 and follow-up questions 510, 512a, 514a may be automatically selected, or may be predetermined depending on authorization from an organization administrator.

Depending upon a user's answers 508, the questions 506 may follow any of several predetermined paths 504, 520. Each of the exemplary predetermined paths 504, 520 shown include a first question 506 followed by a second question 510. The content of the third question 512a, 512b, 512c, however, may vary depending on the answer 516 provided to the second question 510. The second answer 516, may therefore determine which predetermined path 504, 520 the successive questions 514a, 514b follow.

Depending on the predetermined path 504, 520, the user may answer a third question 518 or a fourth question 522, not both. Of course, the predetermined paths 504, 520 shown are provided by way of example and not limitation, as numerous variations of predetermined paths 504, 520 are possible.

As shown in FIG. 5, the server may send definition metadata for all of the questions 506 appearing in all possible predetermined paths 502 of a check-in. A mobile or web-based application may pilot the user through the various paths of questions 506 based on conditions expressed in the programming language embedded in the questions 506. Upon completion of the check-in, the application may send back to the server only the answers 508 to the questions 506 finally taken by the user.

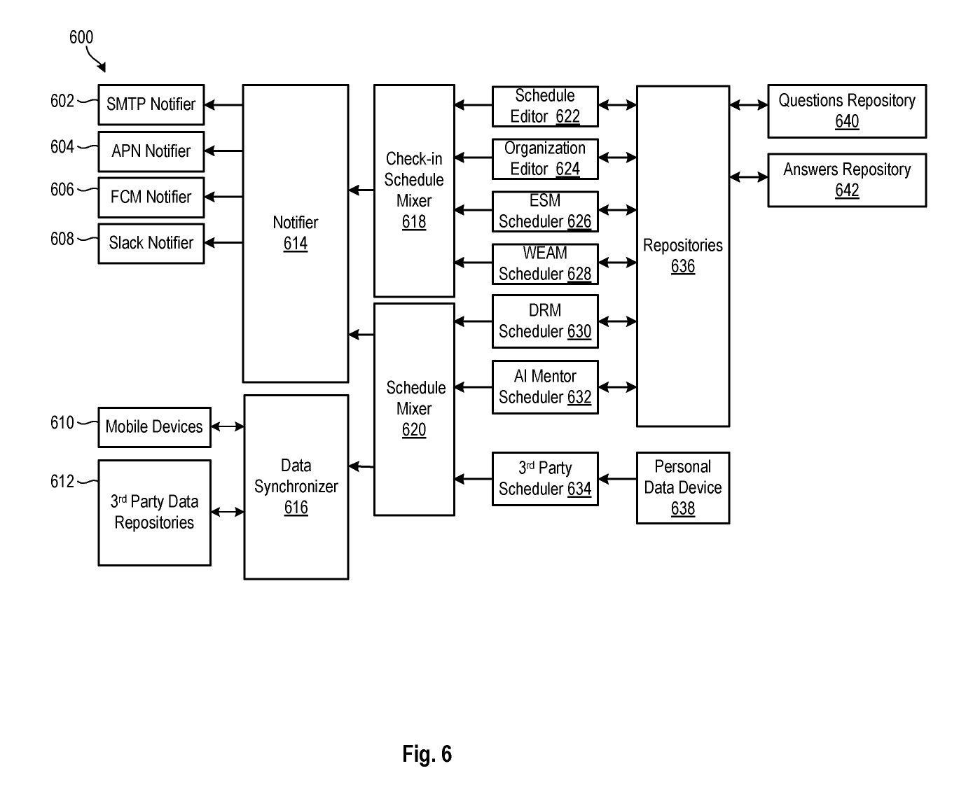

FIG. 6 depicts one embodiment of a server architecture 600 having an interface for client applications to retrieve user data for a check-in. As previously mentioned, a check-in may be a computer program containing instructions for a set of questions, conditional statements that control the flow and input validation of those questions, and metadata for the check-in and its questions. The metadata for each question may contain a question prompt, a question type (e.g., multiple choice, free-form text, ordinal scale, etc.), and additional parameters specific to the question type.

For each question, the conditional statement may be evaluated and, if true, may be presented to a user. For example, in one embodiment a conditional statement may include logic such as “if the user answered to having too much workload,” or “if a random number from 1 to 10 matches this question's question set number.” In some embodiments, this may allow the check-in to dynamically pose different questions based on the user's past answers, behavior, and usage patterns. When the user inputs an answer to that question, that question's input validation routine may be evaluated and, if true, the algorithm may proceed to the next question. Upon completion of the final question, the results may be submitted to the server for storage and processing.

In some embodiments, the server may generate a check-in upon receiving a request from a client application. The server may retrieve the check-in from a repository 636 communicating with a questions repository 640 and an answers repository 642. In some embodiments, the application may receive a push notification from the server to alert the user that a new check-in has been received.

In certain embodiments, a check-in may be scheduled to be performed at a future time by plugging in one or more configurable components. For example, in one embodiment, a schedule editor 622 may automatically schedule a check-in for a user at specific dates and times using a check-in schedule mixer 618. In an alternative embodiment, an organization editor 624 may utilize a check-in schedule mixer 618 to schedule specific dates and times for check-ins according to instructions from an authorized organization administrator. The schedule editor 622 or organization editor 624 may notify the user of the check-in's scheduled time using a notifier 614 as configured in the user's notification settings.

In yet another embodiment, an ESM scheduler 626 may schedule a check-in for a user using an algorithm for the Experience Sampling Method (“ESM”), where users may be prompted to respond to questions at the exact moment they are asked. In this manner, the ESM method may be considered the gold standard to measure momentary experience, although this method may be difficult to implement in large and complex population samples because it may be highly disruptive when used at scale in the workplace.

In this embodiment, each user's workday may be subdivided into a number of equal time periods as defined by a “samples per day” parameter. A random time may then be selected from each time period using a random number generator, such as check-in schedule mixer 618, that draws from a uniform probability distribution. In some embodiments, this process may be repeated each day, and check-ins may be scheduled at each of these random times. In one embodiment, the ESM scheduler 626 may notify the user of the check-in's scheduled time using a notifier 614 as configured in the user's notification settings.

For example, in some embodiments, an SMTP notifier 602 may send an email to a user by communicating via a standard Internet protocol with a remote SMTP server. In other embodiments, an APN notifier 604 may send a push notification to an iOS device by communicating with an Apple Push Notification Service (“APNs”) remote server. An FCM notifier 606 may send push notifications to an Android device by communicating with a Firebase Cloud Messaging (“FCM”) remote server. A slack notifier 608 may send a private message to a user by communicating with a remote server from a third-party messaging service, such as Slack, Facebook Messenger, or the like.

In another embodiment, a WEAM scheduler 628 may schedule a check-in for a user using an algorithm for the Work Experience Assessment Method (“WEAM”), where each user's workday is subdivided into a number of equal time periods as defined by a “samples per day” parameter. A random time may then be selected from each time period using a random number generator such as a check-in schedule mixer 618 that draws from a uniform probability distribution. This process may be repeated each day, and check-ins may be scheduled at each of these random times. The WEAM scheduler 628 may notify the user of the scheduled time for a check-in using a notifier 614 as configured in the user's notification settings.

The WEAM scheduler 628 may minimize any form of after-the-fact reconstruction by focusing on one episode (of less than an hour, for example), at a time. Indeed, like ESM and Day Reconstruction Method (“DRM”), the WEAM method may be designed to capture emotions in order to measure the subjective well-being of individuals. WEAM, however, may be specifically adapted to the context of work, and may substantially avoid the distorting effects of judgment and memory. Specifically, while ESM may ask the user about his well-being right now, and DRM may ask the user about his well-being during each and every episode of his day, WEAM may ask the user about his well-being during the most recent significant episode of the past work hour, for example.

In one embodiment, WEAM may call for direct observation and may not prompt desired answers. In this manner, the WEAM method and associated WEAM scheduler 628 may be designed to leverage emotions stored in the episodic memory to ensure that: (1) the episodic memory mirrors as pristinely as possible the psychological and emotional dimensions of any given episode; and (2) the experience doesn't trigger early semantic memory that processes the emotions and turns them into ideas and beliefs that can overshadow the nuances of original subjective assessment.

In another embodiment, a DRM scheduler 630 may schedule a check-in for a user using an algorithm for the Day Reconstruction Method (“DRM”), where each user receives one check-in each day. The time of the check-in may be determined by a schedule mixer 620. In some embodiments, the time of the check-in may be the same each day and may fall within a predetermined time interval selected by the user or established by the user's organization. The DRM scheduler 630 may notify the user of the scheduled time of a check-in using a notifier 614 as configured in the user's notification settings.

In some embodiments, the DRM method may allow users to provide rich descriptions of subjective individual experiences related to different activities. While this method may prove effective at understanding the environmental determinants of wellbeing, the notion of “day reconstruction” may require too much time for anyone to document a full work day. As a result, the diversity of episodes that a worker in a company may experience within a day may be overlooked.

In another embodiment, an AI mentor scheduler 620 may schedule a configurable time for each user to receive feedback via an Artificial Intelligence (“AI”) mentor chatbot, as discussed in more detail below. The AI mentor scheduler 620 may execute each of the chatbot's components that have been configured to run on a schedule. In some embodiments, a schedule mixer 620 communicating with the AI mentor scheduler 620 may configure this schedule independently for each chatbot component.

In another embodiment, a third-party scheduler 634 may communicate with a schedule mixer 620 to schedule a configurable, repeating time for each user that executes all attached subcomponents. In some embodiments, the third-party scheduler 634 may contain an interface for plugging in one or more configurable subcomponents, such as a personal data device 638, to communicate with a remote server. In this manner, the third-party scheduler 634 may access a third-party data source, retrieve its data, and store the data in a database.

In certain embodiments, a data synchronizer 616 may communicate with the schedule mixer 620 to synchronize data from the personal data device 638 with data stored in the repositories 636. In some embodiments, this data may be stored in a third-party data repository 612, in a database stored on a mobile device 610, or in any other database or repository known to those in the art.

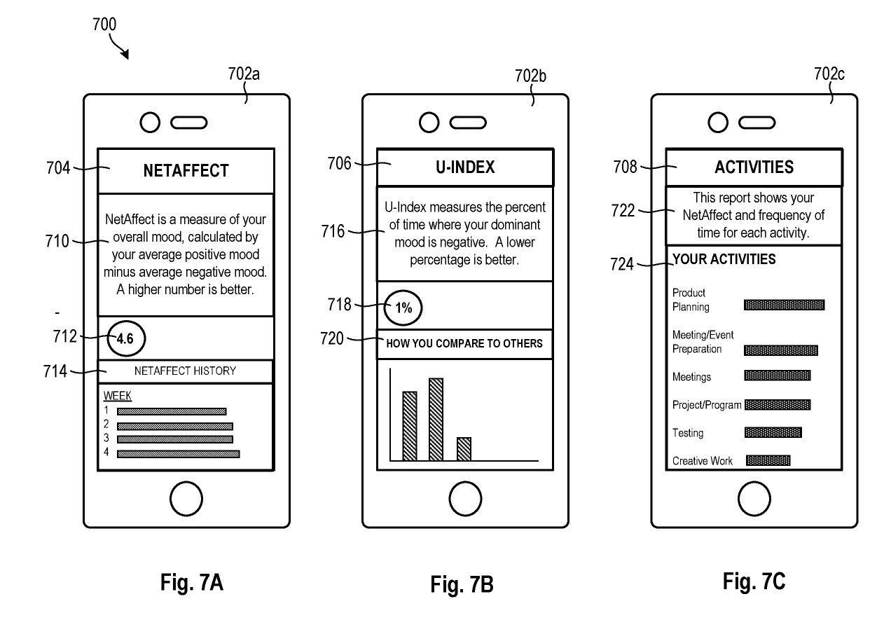

Referring now to FIGS. 7A-C, in certain embodiments, personalized reports 700 may be provided to a user and/or organization based on an analysis of user data. Such personalized reports 704 may be designed to inform a user about trends in topics, such as what the user is doing well, what the user is doing poorly, interesting insights about the user's data, recommendations for improvement, wisdoms about the user's circumstances, and the like. These personalized reports 704 may contain a summary statement and a series of interactive graphs, both of which may be dynamically generated by the component using a template. In certain embodiments, personalized reports 704 may be output as both a simple text summary that omits graphics, and as an HTML document.

In one embodiment, a component may generate a personalized report 704 about the user's experience and wellbeing. The personalized report 704 may display key indicators, such as a line graph of the user's NetAffect™ and emotions over time, superimposed on the same graph. The line graph may be interactive, allowing the user to scroll the line graph across the time axis, or zoom in and out.

A personalized report 704 may further include a timeline of the user's check-in answers and observations related to the data points displayed in the line graph. For example, a data point representing a major dip in the user's NetAffect™ line graph may be related to a check-in where the user answered having too much workload. This information may automatically update to show only information related to the visible data points in the line graph as the user scrolls and zooms the line graph.

In some embodiments, a personalized report 704 may further include computer-generated text summarizing trends and observations in the data.

In another embodiment, a component may generate a personalized report 704 about the user's workload. The personalized report 704 displays key indicators, such as a chart of the user's self-assessed workload, indicating the percentage of time in which the user has too little workload, an ideal amount of workload, or too much workload. The personalized report 704 may also include a line graph of the user's NetAffect™, emotions, and a moving average of the user's workload over time, superimposed on the same graph. The line graph may be interactive, allowing the user to scroll it across the time axis, or zoom in and out.

In some embodiments, the personalized report 704 may further include a timeline of days that the user reported being able to accomplish what they wanted, a cross-tabulation that shows the relationship between the user's amount of workload and their ability to accomplish what they wanted, and/or a computer-generated text summarizing trends and observations in the data.

In another embodiment, a component may generate a personalized report 704 about the user's meetings. This personalized report 704 may display key indicators, such as a pie chart of the user's percentage of time spent in bad meetings and a computer-generated text summarizing trends and observations in the data, for example.

In another embodiment, a component may generate a personalized report 704 about the user's interruptions. This personalized report 704 may display key indicators, such as the user's average number of interruptions per hour compared to other populations of people. For example, the user's interruptions may be compared to the average user, the average user with a similar job position, or the like.

Some embodiments of a personalized report 704 in accordance with the invention may further include a heat map of when the user's interruptions occur most frequently during the workday and/or a computer-generated text summarizing trends and observations in the data.

In another embodiment, a component may generate a personalized report 704 about the user's trust, respect, and ability to speak up. This embodiment of a personalized report 704 may include a bar chart of the user's responses to questions related to trust, respect, and ability to speak up and/or a computer-generated text summarizing trends and observations in the data.

In yet another embodiment, a component may generate a personalized report 704 about the user's predicted patterns of experience and well-being for the near future. In other embodiments, a component may generate a summary report of recommendations and insights for the user, with hyperlinks to accompanying reports for each recommendation and insight.

Personalized reports 704 may be delivered to user device 702a, 702b, 702c associated with the user or organization, such as a mobile device, tablet, cellular telephone, laptop computer, desktop computer, or the like. In this manner, a user may be empowered to improve a workplace environment or situation by gaining individualized awareness and understanding about his or her role and operation in the workplace. Additionally, as set forth in detail below, such reports 700 may provide recommendations regarding way to improve individual or team performance and/or organizational culture.

In one embodiment, as shown in FIG. 7A, a personalized report 704 may contain a timeline and distribution related to a NetAffect™ calculation 712. In some embodiments, the personalized report 704 may contain a description 710 of the NetAffect™ calculation 712, as well as a distribution 714 of the NetAffect™ calculation 712 over time to facilitate the user's understanding and ability to derive benefit from the NetAffect™ calculation 712.

Another embodiment of a personalized report 706, as shown in FIG. 7B, may include a U-index calculation 718 measuring the proportion of time the user spends in a predominately negative mood. A description 716 of the U-index calculation 718 may be provided to facilitate the user's understanding. In some embodiments, the personalized report 706 may further provide a representation 720 of where the user stands compared to other users, and to workers with the same job, and/or to workers within the same company.

Yet another embodiment of a personalized report 708, as shown in FIG. 7C, may provide an analysis of activities 708 in which the user is involved at work relative to the user's emotions, or NetAffect™ calculation 712. The personalized report 708 may contain a description 722 of the analysis, and a graph or other visual representation 724 of various activities of the user relative to the user's emotions or moods.

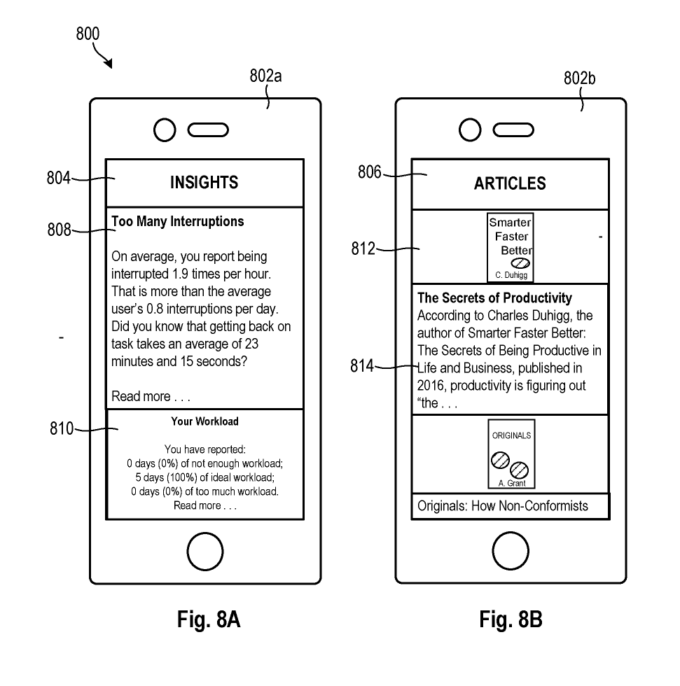

Referring now to FIGS. 8A and 8B, some embodiments of the invention may include a graphical user interface 800 to display recommendations generated in real time and customized to the user based on input data input as well as data received from third party data sources. In some embodiments, the graphical user interface 800 may also display articles or suggested reading material to enable further self-reflection and individual or organizational improvement.

As shown in FIG. 8A, for example, a graphical user interface 800 may be provided on a mobile device 802a associated with a user. The graphical user interface 800 may provide insights 804 generated in real time in response to personal user data received in accordance with embodiments of the invention. Personal user data may include, for example, any data source such as an application, mobile phone, smart watch, sensor, sleep monitoring system, fitness application, or the like.

In some embodiments, one or more of the insights 804 may focus on an area 808 of the user's work experience requiring attention or needing improvement. As shown, for example, the user's workday may have too many interruptions. The insights 804 may describe the problem area 808 and may juxtapose a user's performance in that area 808 with average or desired performance. In some embodiments, the insights 804 may further provide context 810 for the problem area 808, such as analysis of the user's workload.

In another embodiment, as shown in FIG. 8B, a graphical user interface 800 provided on a mobile device 802b associated with a user may display articles 806 or other suggested reading material to facilitate improvement. The graphical user interface 800 may display, for example, a depiction 812 of an article 806, as well as a summary 814 of the article. In some embodiments, the summary 814 may focus on how the article 806 pertains to the user data and analysis. In other embodiments, the graphical user interface 800 may further enable the user to keep track of all of the data that he or she provided in accordance with embodiments of the invention, as well as maintain a free form personal journal.

The scope and nature of the data collection methods described herein, as well as the recommendations and reports generated in accordance with embodiments of the invention may provide users and/or organizations with unique personal knowledge on how they function in the workplace, and how they can develop or improve their capabilities at work.

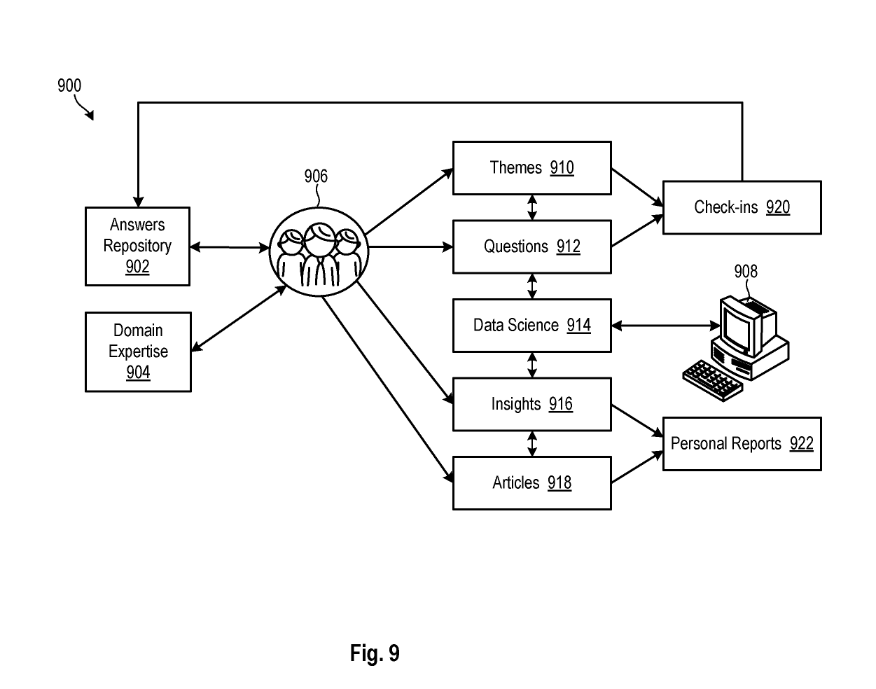

Referring now to FIG. 9, the multi-dimensional qualitative and quantitative analyses provided by embodiments of the invention can be complemented by data coming from other sources. In one embodiment of a system 900 for assessing worker engagement and company culture, for example, a team 906 of domain experts and data scientists may collaborate with each other to benefit from their combined expertise in, for example, psychology, management, applied behavior analysis, ergonomics, occupational health, individual and organizational psychology, wellbeing science, human resources, governance, and the like.

In some embodiments, the team 906 may further consult other sources of domain expertise 904 such as research papers, books, industry papers and articles, and the like. In certain embodiments, measures established by academic research or polling organizations, for example, may be leveraged when available or relevant for validation, contract or comparison purposes.

This domain expertise 904 may facilitate the team's 906 ability to create themes 910 and questions 912 for exploring worker experience and company culture. Each theme 910 may contain multiple questions 912 relating to a topic of interest such as work productivity, satisfaction, behavioral traits of the user, organizational effectiveness, organizational efficiency, or the like. Questions 912 may be weighted to reflect their importance relative to the theme 910.

Questions 912 and themes 910 may be used to create check-ins 920 for a particular user or multiple users. Such domain expertise 904 may also facilitate the team's 906 ability to generate insights 916 and articles 918 for inclusion in connection with an analysis of user data or personal report 922. In some embodiments, the team 906 may also analyze answers stored in an answers repository 902 to create improved check-ins 920 and reports 922 that take into account previous check-in 920 content and results.

In some embodiments, question 912 formulation may also be influenced by data science 914. Particularly, data science 914 may inform the content of the questions 912 by analyzing user input, third-party data, historical user answers, company data, and other such information. In some embodiments, this process may be implemented by software engineers 908, software programming, or the like.

Data science 914 may also inform insights 916 generated and articles 918 generated and/or selected in connection with embodiments of the invention. These insights 916 and articles 918 may be included in personal reports 922 presented to an individual user and/or organization.

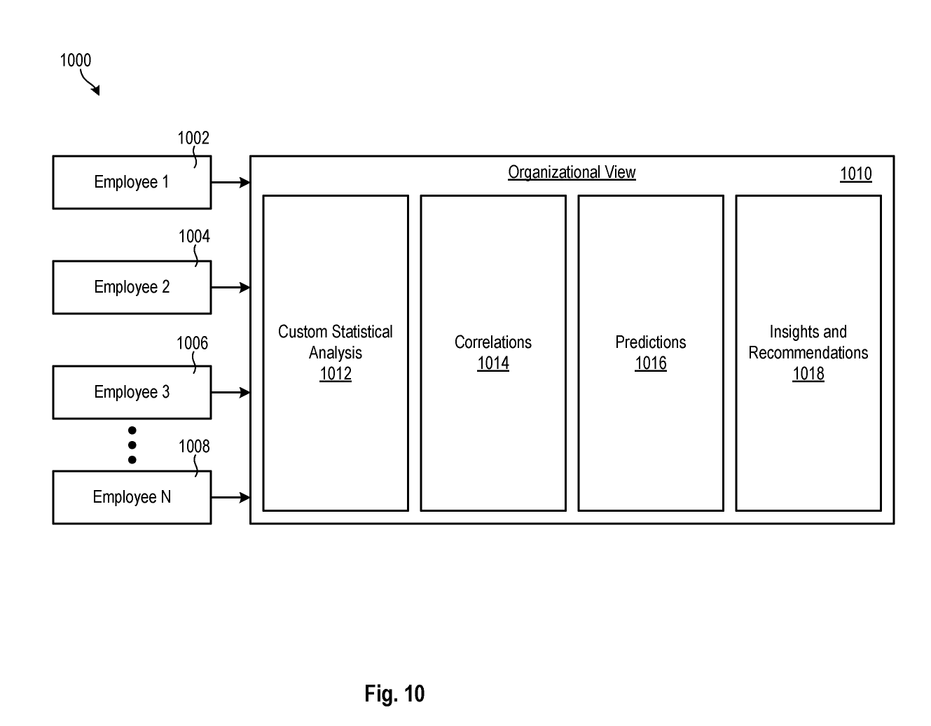

Referring now to FIG. 10, in some embodiments, a system 1000 in accordance with the invention may collect data from multiple users and compile the data for presentation to an organization. The identities of users in the data sets may be protected by applying differential privacy techniques, or other techniques known to those in the art to render users anonymous. This may allow the user to enjoy full data privacy while still preserving the context of the data for reporting to the organization.

In one embodiment, for example, users may include a first worker 1002, a second worker 1004, a third worker 1006, and an nth worker 1008. Data specific to each worker 1002, 1004, 1006, 1008 may be collected via check-ins, personal or biometric data collection, and/or the like. Additional data may also be collected from various third-party sources.

For example, one embodiment may collect internal company data, including financial and performance indicators, quality management, retention and turnover, and the like. The retention and turnover patterns and variables observed in a company may be correlated with user emotions and multiple constructs and sub-constructs. In this manner, embodiments of the present invention may be used as a remediation system by reducing turnover, informing workforce planning, and the like.

In another embodiment, additional data may include industry data aggregated by a system in accordance with the invention. For example, a system server may aggregate data across several organizations and, as a result, may provide insights to companies on where they stand compared to organizations in their space, similar spaces, or different spaces.

In another embodiment, additional data may include external data. External data may include, for example, market data as well as any data that can directly or indirectly influence the life of an organization (location, weather, commutes, etc.). Embodiments of the invention may correlate specific organization findings with external data of any type.

In yet another embodiment, additional data may be gathered from previously-generated reports and recommendations. Because of its ability to manage a large amount of thick data, a system in accordance with embodiments of the invention may generate extremely sophisticated reports and recommendations. These reports and recommendations may be accumulated in a large repository of research papers and internal analysis and accessed to generate insights and recommendations.

Upon collection of both specific and generalized data from various sources, embodiments of the invention may analyze the data and create an organizational view report 1010 for presentation to the organization. In some embodiments, the organizational view report 1010 may include a custom statistical analysis 1012 reflecting the overall state and culture of a company. This custom statistical analysis 1012 may include, for example, an aggregate analysis of users' well-being, including U-index, NetAffect™, and the like. In some embodiments, the custom statistical analysis 1012 may also include an aggregate analysis of user workload, use of time, collaboration, job fit, and the like. A custom statistical analysis 1012 in accordance with embodiments of the invention may include a summary of the results to facilitate an organization's or authorized user's ability to make sense of the data.

In some embodiments, an organizational view report 1010 may further include correlations 1014 between multiple sets and/or sources of data. Correlations 1014 may be key drivers of an organization's effectiveness and efficiency, as they may enable individuals and organizations to easily interpret large amounts of data from multiple data sources, or “thick data,” in view of their goals.

Some embodiments of an organizational view report 1010 may further include predictions 1016, such as for worker turnover, and/or insights and recommendations 1018 based on the combined data. As discussed above, insights and recommendations 1018 may include articles, suggested reading materials, and insights including comparisons with other organizations, a historical view of an organization's performance, or the like.

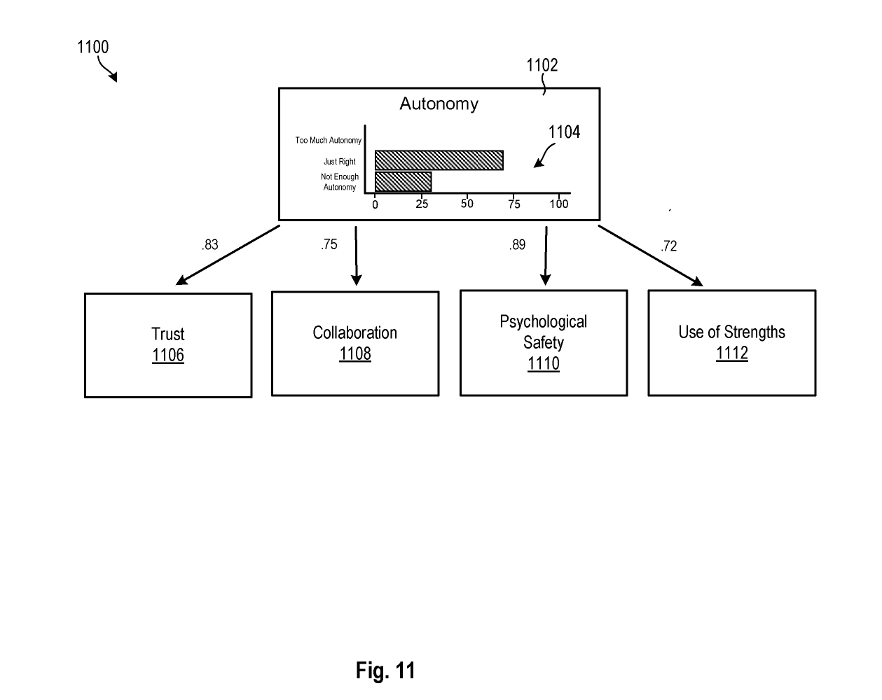

FIG. 11 depicts one example of correlations 1100 between an autonomy construct 1102 and its components for a team of nurses. As shown, a particular construct 1102 may have different degrees of correlation to other constructs such as trust 1106, collaboration 1108, psychological safety 1110, use of strengths 1112, and the like. These degrees of correlation may also vary among different sub-groups of individuals. In some embodiments, the quantitative and qualitative analysis associated with in vivo data collection may be combined with more static data such as age, gender, ethnicity, etc., for a complete demographic analysis of the workforce.

Research has exhibited the recurrence of dozens of behavioral constructs in the workplace and identified the most common ones. The relevance and hierarchy of these constructs 1102, however, vary across companies. From usage over time of the platform, machine learning in accordance with certain embodiments of the invention may enable automated modeling of constructs 1102, sets of constructs 1102, and sub-constructs that tend to get sampled over and over again in a given company, or that are typically related to specific areas of interests, such as diversity and inclusion monitoring, for example.

In one embodiment, overall satisfaction of a group of individuals relative to an autonomy construct 1102 may be depicted by a graph or other visual representation 1104, as shown. Further, in the depicted embodiment, an autonomy construct 1102 for a team of nurses may bear various relationships with other constructs 1102. For example, the relationship between an autonomy construct 1102 and a trust construct 1106 may be 0.83, while the relationship between the autonomy construct 1102 and a collaboration value may be 0.75, the relationship between the autonomy construct 1102 and a psychological safety 1110 construct may be 0.89, and the relationship between the autonomy construct 1102 and a use of strengths construct 1112 may be 0.72. These relationships may enable a user or organization to better interpret the meaning of the graph or other visual representation 1104 of overall satisfaction with the autonomy construct 1102.

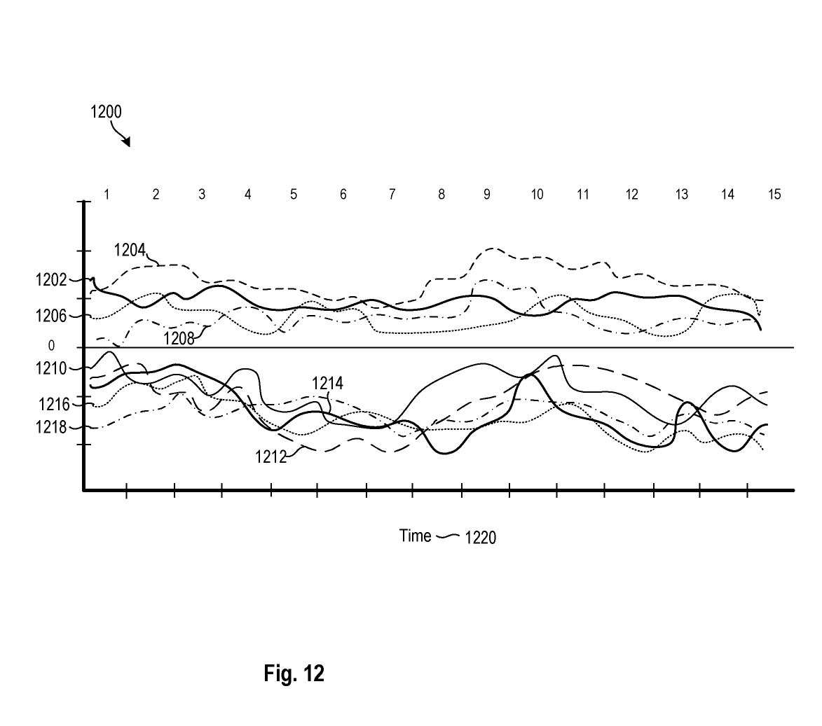

Referring now to FIG. 12, in some embodiments, a customized organizational report 1200 may be generated to inform the user about trends in topics such as the organization's overall experience and well-being, behavioral issues in the organization, overall worker experience and well-being, and the like. The amount of data points provided by combined data collection methods in accordance with embodiments of the invention far exceeds the amount of data collected by context-free sweeps of conventional structured or unstructured polling or feedback methods. As a result, a customized organizational report 1200 in accordance with embodiments of the invention may provide employers and organizations with a high definition image of the worker experience.

In certain embodiments, this organizational report 1200 may contain a summary statement and series of interactive graphs, both of which may be dynamically generated by a configurable component using a template. In some embodiments, an organizational report 1200 may be output as both a simple text summary that omits graphics, and as an HTML document.

For example, in one embodiment, the configurable component may generate an organizational report 1200 about the organization's predicted risk of worker turnover using the output of machine learning system, as described in detail below. In another embodiment, the configurable component may generate a organizational report 1200 about the experience and well-being of the organization's workers. This report may display key indicators, such as a series of interactive charts representing the aggregate moods of the organization's members, including but not limited to: happiness, frustration, confidence, worry/anxiety, feeling valued, boredom, stress/pressure, tiredness, enjoyment, and the like. In other embodiments, the report may display an interactive chart representing worker job satisfaction. In one embodiment, the report may further display a score representing the predicted risk of worker turnover.

In certain embodiments, as shown in FIG. 12, a pluggable component may generate a organizational report 1200 about the workload, stress levels, and energy levels of the organization's workers over a period of time 1220. This may serve as a barometer to track the level of burnout among the organization's workers. This organizational report 1200 may display key indicators, such as a series of interactive charts representing the aggregate moods of the organization's workers, including but not limited to: happiness 1204, frustration 1216, confidence 1208, worry/anxiety 1218, feeling valued 1202, boredom 1210, stress/pressure 1214, tiredness 1212, enjoyment 1206, etc. In some embodiments, the organizational report 1200 may further include an interactive chart representing workload among the organization's members and/or a score representing the predicted risk of burnout across the organization. In one embodiment, the organizational report 1200 may further include a summary of recommendations and insights for the organization, with hyperlinks to accompanying reports or suggested reading material.

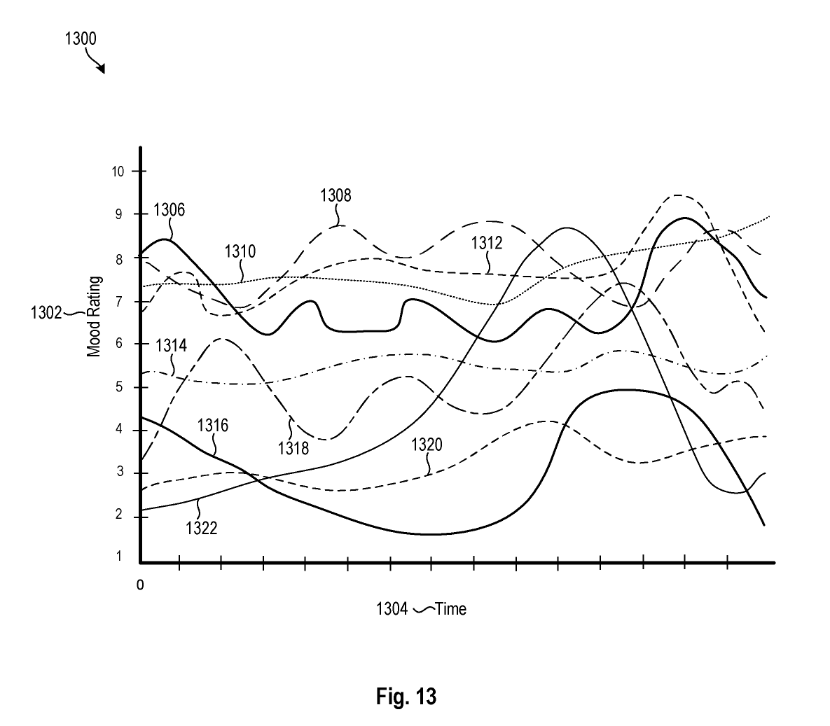

Referring now to FIG. 13, in another embodiment of an organizational report 1300, “well-being” or “ill-being” may be viewed as a multi-dimensional reality that may be analyzed and related to particular contexts. As shown, for example, a mood rating 1302 may be correlated with an emotion over time 1304. Emotions may include, for example, enjoyment 1306, happy 1308, confidence 1310, feeling valued 1312, worried/anxious 1314, bored 1316, frustrated 1318, stressed 1320, tired 1322, or the like. Mapping emotions in this manner may also facilitate other correlations and inferences. For example, tiredness 1322 may be closely related to other constructs, such as workload, poor communication, conflict, etc.

In some embodiments, tying emotions to the specific contexts where they occur may enable organizations to track particular constructs and sub-constructs within such contexts. For example, a job satisfaction construct may be correlated with other constructs such as teamwork, affective commitment to the organization, salary, nature of the work, ability to learn, security, self-esteem, feeling valued, meaning of the work, social events, and the like.

Constructs that are part of another construct (components or sub-constructs) may vary considerably across companies, sectors, and cultures. For example, in a company where workers have primarily routine and repetitive tasks, sub-components such as security, salary, self-esteem, social events, citizen behavior, and value congruence may have a higher relevance than constructs related to “professional development” or “creativity.”

The richness of the data sets provided by embodiments of the invention enables companies and organizations to establish scientific correlations between a given construct and its components, and to test the correlation indices of each component. These data sets also enable companies and organizations to define operational measures and strategy improvements with high predictive utility.

The comprehensiveness and accuracy of data collection and analysis systems and methods in accordance with embodiments of the invention may enable organizations to adapt management styles to their concrete situation instead of applying the same management model to all situations. For example, if workers value autonomy and trust is pervasive, it may be beneficial to reduce supervision procedures with little risk to adversely impacting quality control.

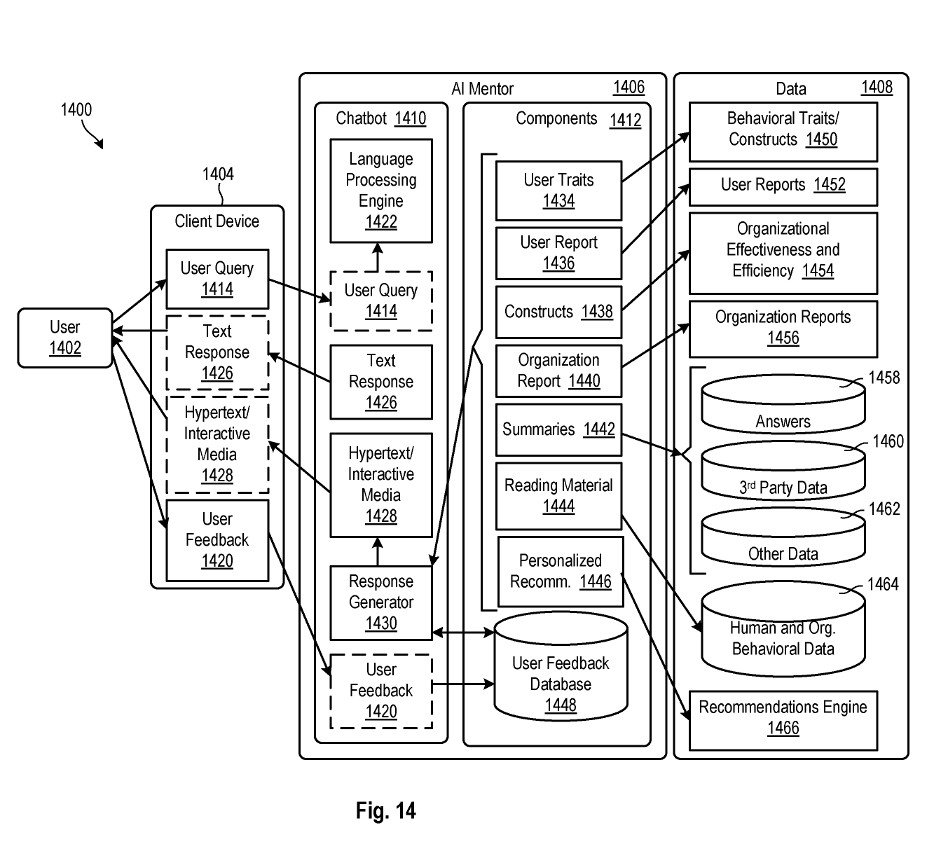

Referring now to FIG. 14, some embodiments of a system for assessing worker engagement and company culture in accordance with the invention may include an artificial intelligence (“AI”) AI mentor 1406 to collect data 1408 from a user 1402 in substantially real time. In some embodiments, the AI mentor 1406 may communicate with the user 1402 via interactive queries to a client device 1404 such as a mobile device or telephone, tablet, laptop computer, desktop computer, or the like. In one embodiment, the client device 1404 may present an interactive query from the AI mentor 1406, in addition to a conversational view of the user's chat history with the AI mentor 1406. In another embodiment, the AI mentor's 1406 responses may also be displayed on the client device 1404 using HTML rendering techniques.

In some embodiments, the AI mentor 1406 may include a chatbot 1410 running on a server. The chatbot 1410 may respond to user queries from a client device 1404 by matching the user's text or speech query 1414 to a user intent using a language processing engine 1422, for example. In one embodiment, a language processing engine 1422 may utilize Natural Language Processing (“NLP”) algorithms. The chatbot 1410 may then search an interface associated with the AI mentor 1406 for a component 1412 that is configured to process this user intent. In one embodiment, the chatbot 1410 may utilize a set of rules defined by a server administrator to locate the component 1412, execute the component 1412 with the user query 1414, and return the output of the component 1412 to the client device 1404 of the user 1402.

Depending on the output capabilities of the client device 1404, the output of the component 1412 may be returned as a series of hypertext and interactive media 1428, a short text response 1426, or the like. In some embodiments, the hypertext and interactive media 1428 or text response 1426 may be formatted by a predefined template for the component 1412 and output method.

These components 1412 may include, for example, a component 1434 that answers queries related to the output of the machine learning system for the user's behavioral traits 1450; a component 1436 that retrieves and outputs a requested personalized report 1452 about the user from a server and displays them to the user 1402; a component 1438 that answers queries related to the output of the machine learning system for organizational effectiveness and efficiency 1454; a component 1440 that retrieves and outputs a requested customized reports 1456 about the user's organization from a server and displays them to the user 1402; and/or a component 1442 that summarizes statistics of requested variables from a user's various data sources 1458, 1460, 1462. In some embodiments, such data sources 1458, 1460, 1462 may include answers 1458 to check-in questions, data 1460 from third-party APIs, and the like.

In other embodiments, a component 1412 may include, for example, a component 1440 that summarizes the statistics of requested variables from an organization's various data sources 1456 and its users' various data sources. For example, this data may include answers to check-in questions, data from third-party APIs, data from the human resources department, data from the sales department, and the like.

In another embodiment, a component 1412 may include, for example, a component 1444 that searches for user-supplied keywords and retrieves recommendations and suggested reading material from a knowledge database 1464 of human and organizational behavior, and/or a component 1446 that retrieves personalized recommendations from a recommendation engine 1466 for suggested reading material.

In certain embodiments, a recommendation engine 1466 may suggest reading material by using a collaborative filtering algorithm that averages the output of a matrix factorization algorithm and multiple Restricted Boltzmann Machines that are trained on input vectors of user behavioral traits and constructs, including, for example, answers to check-in questions, usage habits, user preferences, and the like.

In one embodiment, components 1412 may include a component 1448 that records user feedback 1420 about the chatbot 1410 and the output of each of its components 1412. This feedback 1420 may be submitted by the user 1402 via: (1) a button or other indicator that may accompany a chatbot response 1430; or (2) a request from the user 1402 in which user intent is identified as quality feedback 1420 via semantic analysis. For example, such a request could be, for example, “That wasn't what I wanted,” or “Thanks”. This feedback 1420 may be recorded into a database 1448 and used as a source of data for adjusting associated components 1410.

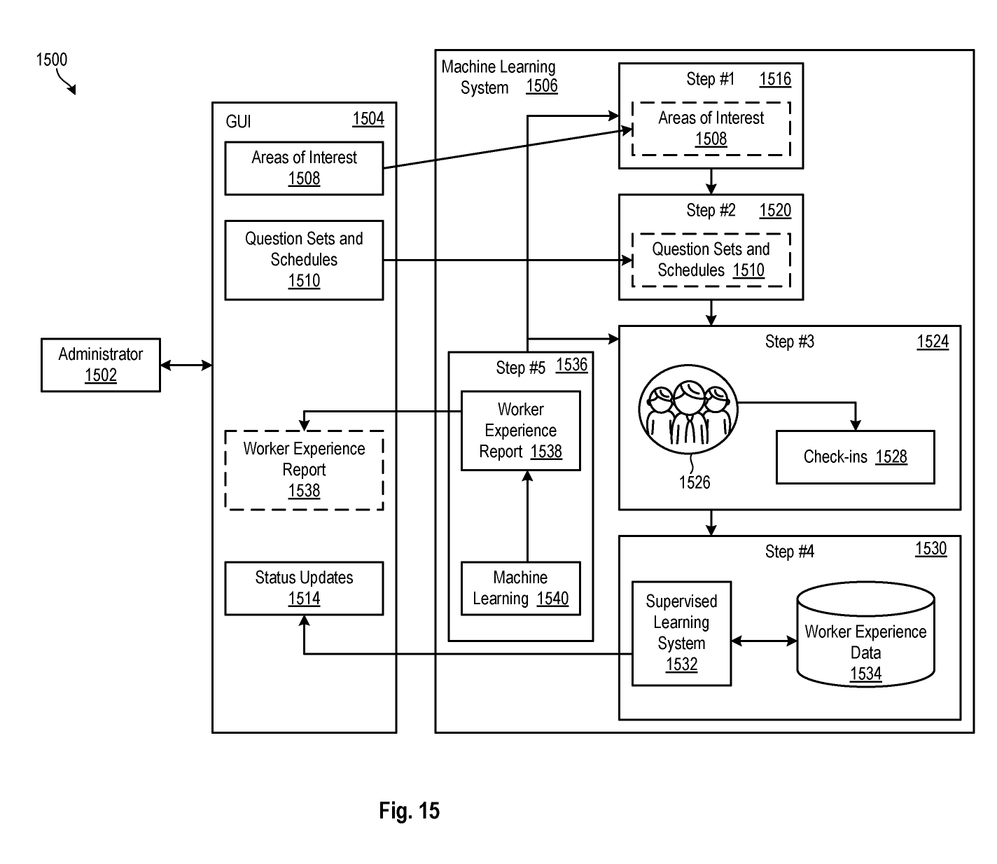

Referring now to FIG. 15, certain embodiments of a method 1500 in accordance with the invention may utilize a machine learning system 1506 to guide an organization administrator 1502 through a sequence of tasks, as follows:

1. A graphical user interface 1504 may query the organization administrator 1502 to assess areas of interest 508 that the organization is interested in evaluating.

2. Based on input from the organization administrator 1502, a suggested configuration of customizable question sets and check-in schedules 1510 may be presented to the organization administrator 1502.

3. The organization administrator 1502 may be guided through a study of a selection of workers 1526 for a period of time. This study may include check-ins 1528 utilizing an ESM schedule, DRM schedule, WEAM schedule, or other custom check-in schedule as configured by the organization administrator 1502.

4. During the study period, the computer system regularly provides the organization administrator 1502 with a series of progress reports in the form of status updates 1514 via e-mail and other forms of notification. In some embodiments, a supervised learning algorithm or system 1532 may be used to estimate or project a date when enough worker experience data 1534 has been collected, at which time the study may be complete.

5. Upon completion of the study, a final report 1538 of the study may be generated. In some embodiments, the final report 1538 may be sent to the organization administrator 1502 via e-mail or the like. The final report 1538 may be generated using machine learning, predictive analysis, statistical analysis for worker experience, and the like.

6. The final report 1538 may further encourage the organization administrator 1502 to implement changes and to return to Step #3 to measure the effects of those changes. Otherwise, the entire process may repeat from Step #1.

In this manner, in one embodiment, a machine learning system 1506 in accordance with embodiments of the invention may classify a user as having a series of behavioral traits by aggregating the outputs of a combination of supervised and unsupervised learning models that are trained on a high-dimensional dataset. This dataset may include answers from user check-insights 804, sentiment analysis of user communications, user data from third-party data sources, and organizational data.

In some embodiments, the output of this system may generate: (1) a series of scores that rate the model's belief in the user having each behavioral trait, and (2) a clustering of the variables from the data set, segregated by their magnitude of positive, neutral, or negative contribution to each score. Finally, each score and each clustering of variables may be inputted into an expert system in accordance with embodiments of the invention to produce recommendations derived from a knowledge database of human and organizational behavior.

In another embodiment, a machine learning system 1506 may identify both positive qualities and problem areas in the key drivers of organizational effectiveness and efficiency constructs. The main areas of organizational effectiveness may include, for example, leadership, accountability, performance, communication, processes, and metrics. The main areas of organizational efficiency may include return on investment (“ROI”) and return on human capital.

In operation, the outputs of a combination of supervised and unsupervised learning models that are trained on a high-dimensional dataset may be aggregated. This combined dataset may include answers from user check-ins, sentiment analysis of user communications, user data from third-party data sources, and organizational data from third-party data sources. In some embodiments, the output of this system may generate: (1) a series of scores that rate each main area of organizational effectiveness and efficiency, and (2) a clustering of the variables from the data set, segregated by their magnitude of positive, neutral, or negative contribution to each score. Finally, each score and each clustering of variables may be inputted into an expert system in accordance with embodiments of the invention to produce recommendations that are derived from a knowledge database of human and organizational behavior.

In another embodiment, a machine learning system 1506 in accordance with the invention may predict the risk of worker turnover by aggregating the outputs of a combination of supervised and unsupervised learning models that are trained on a high-dimensional dataset. This dataset may include, for example, answers from user check-ins, sentiment analysis of user communications, user data from third-party data sources, and organizational data from third-party data sources. Particularly, in one embodiment, one such dataset may contain answers to check-in questions related to stress and job satisfaction, historic trends within the organization, economic trends in the organization's industry, HR data indicating changes in key job positions and rate of worker complaints, worker compensation trends compared to industry norms, and the like.

What is claimed is:

1. A method for assessing worker engagement and company culture, comprising:
generating, by a server, a plurality of questions relating to a user's work experience;
determining a set of predetermined times during the user's work day to prompt the user to answer the plurality of questions;
prompting the user at each of the predetermined times to provide an answer, in real time, to each the plurality of questions;
receiving, by the server, the answers from the user; and
correlating, by the server, the answers with contextual data associated with the user.

2. The method of claim 1, further comprising syncing data from at least one data gathering device associated with the user.

3. The method of claim 2, wherein the contextual data comprises at least one of other answers and data from the at least one data gathering device.

4. The method of claim 1, wherein prompting the user comprises pushing the plurality of questions to the user from the server.

5. The method of claim 1, wherein prompting the user comprises providing the plurality of questions on at least one of a mobile application and a web-based application.

6. The method of claim 1, wherein the predetermined times fall within at least one interval of time selected by the user.

7. The method of claim 1, further comprising generating, by the server, a report based on the plurality of questions, the answers, and the contextual data.

8. The method of claim 7, wherein the report comprises at least one of an article and suggested reading material selected for the user.

9. The method of claim 8, further comprising providing the report to the user.

10. The method of claim 7, further comprising generating an organizational report for presentation to an organization, the organizational report comprising an analysis of data from a plurality of users to provide insights regarding organizational culture, wherein each of the plurality of users is anonymous.

11. A system for assessing worker engagement and company culture, comprising:
at least one server; and
at least one memory device operably coupled to the at least one server and storing instructions for execution on the at least one server, the instructions causing the at least one server to:
generate a plurality of questions relating to a user's work experience;
determine a set of predetermined times during the user's work day to prompt the user to answer the plurality of questions;
prompt the user at each of the predetermined times to provide an answer, in real time, to each the plurality of questions;
receive the answers from the user; and
correlate the answers with contextual data associated with the user.

12. The system of claim 11, wherein the instructions further cause the at least one server to sync data from at least one data gathering device associated with the user.

13. The system of claim 12, wherein the contextual data comprises at least one of other answers and data from the at least one data gathering device.

14. The system of claim 11, wherein prompting the user comprises pushing the plurality of questions to the user from the server.

15. The system of claim 11, wherein prompting the user comprises providing the plurality of questions on at least one of a mobile application and a web-based application.

16. The system of claim 11, wherein the predetermined times fall within at least one interval of time selected by the user.

17. The system of claim 11, wherein the instructions further cause the at least one server to generate a report based on the plurality of questions, the answers, and the contextual data.

18. The system of claim 17, wherein the instructions further cause the at least one server to provide the report to the user.

19. The system of claim 17, wherein the instructions further cause the at least one server to generate an organizational report for presentation to an organization, the organizational report comprising an analysis of data from a plurality of users to provide insights regarding organizational culture, wherein each of the plurality of users is anonymous.

20. A computer program product comprising a computer-readable storage medium having computer-usable program code embodied therein, the computer-usable program code configured to perform the following when executed by at least one server:
generate a plurality of questions relating to a user's work experience;
determine a set of predetermined times during the user's work day to prompt the user to answer the plurality of questions;
prompt the user at each of the predetermined times to provide an answer, in real time, to each the plurality of questions;
receive the answers from the user; and
correlate the answers with contextual data associated with the user.
